(19) United States
(12) Patent Application Publication
(10) Pub. No.: US 2026/0049958 A1
(43) Pub. Date: Feb. 19, 2026

(54) CAPILLARY GEL ELECTROPHORESIS SEPARATION OF DIASTEREOMERS OF PHOSPHOROTHIOATED OLIGONUCLEOTIDES

(71) Applicant: Synthon B.V., Nijmegen (NL)

(72) Inventor: Pavol DURC, Blansko (CZ)

(21) Appl. No.: 19/124,188

(22) PCT Filed: Oct. 23, 2023
(86) PCT No.: PCT/EP2023/079519

§ 371 Date: Apr. 24, 2025

(30) Foreign Application Priority Data
Oct. 25, 2022 (EP) 22203518.0

(51) Int. Cl. G01N 27/447

(52) U.S. Cl. CPC G01N 27/44747; G01N 27/4473

(57) ABSTRACT

Method of identification and/or characterization of diastereomers mixtures of phosphorothioate oligonucleotides by capillary gel electrophoresis with a background electrolyte that has a pH 6 to 8, comprising the steps of: a) Preparing a gel matrix by dissolving a water soluble polymer containing a side chain having a functional group that interacts with diastereomers mixture to be analysed in a background electrolyte; b) Introducing the gel matrix in the capillary; c) Introducing the sample of diastereomers mixture of phosphorothioate to capillary; d) Applying an electric field greater than 200 volts/cm of capillary across the gel matrix in the capillary; e) Detecting the individual diastereomers and/or the characteristic groups of partially separated diastereomers of phosphorothioate oligonucleotides.

### BACKGROUND OF THE PRESENT INVENTION

Capillary gel electrophoresis (CE) is a type of electrophoresis in which charged biomolecules are separated based on their size and charge by filling a capillary tube with a gel matrix and applying the electrical field. This technique can also be used for the separation of isomers of biomolecules, for instance diastereomers of oligonucleotides.

The use of capillary gel electrophoresis for the separation of DNA diastereomers is described in Electrophoresis 2000, 21, 2999-3009 wherein the difficulties related to the separation of DNA diastereomers are explained as well as some improved electrophoresis conditions that result in a maximum separation of 8 diastereomers of phosphorothioate oligonucleotides.

However, most of the commercially available pharmaceutical products comprising phosphorothioate oligonucleotides have a higher amount of diastereomers. It is therefore important to provide a method that is robust and allows identification of different diastereomers in more complex mixtures.

### DETAILED DESCRIPTION OF THE PRESENT INVENTION

The present invention relates to a method for the separation and/or characterization of diastereomers of phosphorothioate oligonucleotides by capillary gel electrophoresis and the use of this method to differentiate between batches with different diastereomers composition of phosphorothioate oligonucleotides and select the ones that complies with a predetermined specification.

A first aspect of the invention relates to a method of identification and/or characterization of diastereomers mixtures of phosphorothioate oligonucleotides by capillary gel electrophoresis with a background electrolyte that has a pH 6 to 8, comprising the steps of:
a. Preparing a gel matrix by dissolving a water soluble polymer containing a side chain having a functional group that interacts with diastereomers mixture to be analysed in a background electrolyte (BGE);
b. Introducing the gel matrix in the capillary;
c. Introducing the sample of diastereomers mixture of phosphorothioate oligonucleotides to capillary;
d. Applying an electric field greater than 200 volts/cm of capillary across the gel matrix in the capillary;
e. Detecting the individual diastereomers and/or the characteristic groups of partially separated diastereomers of phosphorothioate oligonucleotides.

A number of forms of electrophoretic separations are known in the art. These include, but are not limited to, slab gel, capillary electrophoresis, electrofiltration, differential in gel electrophoresis, zone electrophoresis, isoelectric focusing, native electrophoresis, 2-dimensional electrophoresis, immunochemical/immunofixation electrophoresis, immobilized pH gradient electrophoresis, microchips, moving boundary, isotachophoresis, pulse-field electrophoresis, as well as combinations of these.

These technics are well known in the art and are taught extensively in the literature, including: Beckman Coulter's booklet “Introduction to Capillary Electrophoresis”, Whatley, H., “Basic Principles and Modes of Capillary Electrophoresis”, in Petersen and Mohammad, eds., and Lauer and Rozing, eds., “High Performance Capillary Electrophoresis”, 2nd Ed., Agilent Technologies, Inc., Santa Clara, CA (2014).

In gel electrophoresis, analytes are subjected to an electric force, which causes the analytes to migrate through the gel.

The gel used in gel electrophoretic separations may be created by any means known in the art. In the invention, a preferred method to prepare the gel is dissolving the water soluble polymer containing a side chain having a functional group that interacts with the diastereomers mixture to be analysed in background electrolyte, but optionally the water soluble polymer containing a side chain having a functional group that interacts with diastereomers mixture to be analysed can be dissolved in water, followed by introduction of background electrolyte to form a matrix.

Background electrolyte is a solution of a buffering salt. Preferably, the background electrolyte used in the present invention has a pH from 6 to 8, more preferably the pH is from 6.2 to 7.8 most preferred the pH is from 6.5 to 7.5.

Preferred background electrolyte solutions to be used according to the invention are 2-(N-morpholino)ethanesulfonic acid (MES)/histidine(HIS), 2-[4-(2-Hydroxyethyl)piperazin-1-yl]ethane-1-sulfonic acid (HEPES)/HIS or HEPES/2-[Bis(2-hydroxyethyl)amino]-2-(hydroxymethyl)-1,3-propanedio (Bis-Tris).

Each component of the background electrolyte solutions is independently preferably in the a concentration range from 0.02 to 0.3M, more preferably from 0.05 to 0.25M, even more preferably from 0.1 to 0.22M, most preferred from 0.15 to 0.2M.

The polymers to be used according to the present invention are water soluble polymers containing a side chain having a functional group that interacts with diastereomers mixture to be analysed.

Examples of functional groups of this side chain are CO, COOR, CONH₂, COOH, where R can be defined as a lineal or cyclic alkyl, akenyl or akynil group.

Examples of polymers containing a side chain having a functional group that interacts with diastereomers mixture to be analysed are: polyvinylpyrrolidone (PVP), “co-polymer of PVP and vinyl acetate” or Poly(2-ethyl-2-oxazoline) (PEOX). For instance, PVP 40,000; PVP 360,000; PVP 1,300,000; Poly(1-vinylpyrrolidone-co-vinyl acetate) 50,000, PEOX 50.000 or PEOX 500.000 can be used as a polymer.

In a preferred embodiment PVP 50.000, PVP 1.3M and “co-polymer of PVP and vinyl acetate” are used.

The water soluble polymer containing a side chain having a functional group that interacts with diastereomers mixture to be analysed from the invention is preferably used in a concentration of more than 3% w/v, more preferably 3-30% w/v, even more preferably from 5-20% w/v.

In many instruments, the gel is disposed in one or more containers, the end of a capillary is introduced into the gel, and the gel is driven into the capillary, typically by air pressure.

Alternatively, the gel may be disposed in a cartridge and driven into a capillary fluidly connected to the cartridge, facilitating changes of gel in the capillary between analyses of samples. The cartridges are typically designed for use in an analytical instrument configured to accept them, such as the gel cartridges configured for use with a GL 1000 glycan analyzer (BiOptic Inc., New Taipei City, Taiwan (R.O.C)), and preferably allow quick changes of gels, expediting a series of analyses. Typically, the gel is made in bulk, dispensed into cartridges, and cartridges already filled with the gel of choice are then purchased by the practitioner intending to use the cartridge to perform capillary gel electrophoresis separations in an instrument configured to receive the cartridge.

Most current capillary electrophoresis instruments are designed to wash the capillary between each run of sample and to introduce fresh gel into the capillary. Such washes are referred to as “regenerating” or “conditioning” the capillary, and are used in many CE protocols to improve reproducibility. D. Heiger, “High performance capillary electrophoresis, and introduction” (Agilent Technologies, Publication 5968-9963E, Germany, 2000) (“Heiger”), p. 92, for example, states that capillaries can be conditioned by washing them with a strong base, with a strong acid, with an organic compound such as methanol or DMSO, or with a detergent, and following the wash by a rinse.

In another embodiment, the temperature of the capillary is thermostated to temperatures from 5 to 25° C., preferably from 7 to 20° C., more preferably from 10 to 15° C.

Once the gel is in the capillary, the sample is contacted with the gel by means known by the skilled person. For instance, introducing the sample dissolved in water or background electrolyte into the capillary by electrokinetic injection or hydrodynamic injection. The use of an electrokinetic injection is preferred.

Once the sample is loaded to the capillary, an electric field is applied. Preferably, a field greater than 200 volts/cm of capillary, more preferably a field greater than 400 volts/cm of capillary, even more preferably a field from 400 to 1000 volts/cm of capillary, most preferred a field from 500 to 700 volts/cm of capillary is applied.

The sample is then run through the gel, and the diastereomers and/or the characteristic groups of partially separated diastereomers of phosphorothioate oligonucleotides are detected by UV, infrared, fluorescence, laser-induced fluorescence or other external monitoring methods. In a preferred embodiment, a UV detector is used. The preferred wavelength if the UV detector is used is from 240 to 280 nm, preferably 260 nm.

In a preferred embodiment, diastereomers of a phosphorothioate oligonucleotide are totally or partially separated and/or characterized with a capillary gel electrophoresis method with a background electrolyte that has a pH 6.5 to 7.5 comprising the steps of:
a. Preparing a gel matrix by dissolving a water soluble polymer containing a side chain having a functional group that interacts with diastereomers mixture to be analysed, preferably polyvinylpyrrolidone 1.3M or “co-polymer polyvinyl-pyrrolidone and vinylacetate”, in a background electrolyte, preferably MES/HIS, HEPES/HIS or HEPES/Bis-Tris;
b. Introducing the gel matrix in the capillary;
c. Introducing the sample of diastereomers mixture of phosphorothioate to capillary;
d. Contacting the gel matrix with a sample of diastereomers mixture of phosphorothioate oligonucleotides;
e. Applying an electric field greater than 200 volts/cm of capillary across the separation substrate in the capillary.

The method of the invention is very robust and can be used to totally or partially separate diastereomers of phosphorothioate oligonucleotides of any length. In a preferred embodiment, the phosphorothioate oligonucleotide is at least a 5-mer.

Phosphorothioate oligonucleotide may encompass oligonucleotides where all internucleoside bonds are of phosphorous-sulphur type and oligonucleotide that comprises a mixture of both bonds; phosphorous-sulphur and phosphorous-oxygen.

In phosphorothioate oligonucleotides, when an oxygen is substituted with a sulphur, generates a chiral center. These chiral centers generate diastereomers. The method of the present invention can be applied to any phosphorothioate oligonucleotide with chiral centers that generate diastereomers. Examples of these phosphorothioate oligonucleotides are: nusinersen, inotersen, volanesoren, inclisiran, givosiran, lumasiran, nedosiran, vutrisiran, cemdisiran and fitusiran.

For instance, nusinersen is a phosphorothioate antisense oligonucleotide consisting of 18 nucleotide residues which is used for treatment of Spinal muscular atrophy (SMA). Nusinersen exhibits stereoisomerism due to the presence of multiple chiral centers. In total nusinersen has 2¹⁷=131072 isomers.

The method of the invention as described above is particularly useful when an oligonucleotide has a higher number of nucleotides and the total separation of the diastereomers is complex. In practice the method of the invention can be used to discriminate between batches with different diastereomers composition of phosphorothioate oligonucleotides as well as to evaluate sameness between batches by comparing the electropherogram of different batches manually (such as visual inspection by the practitioner of the method or comparison of the different samples by comparing the migration times in the peak tops) or it may be automated (such as statistically evaluation).

The method of the invention can be used for batch release or for in process control during the synthesis of a phosphorothioate oligonucleotide. For instance to select and/or discriminate batches during the synthesis of a phosphorothioate oligonucleotide.

In another embodiment, the capillary gel electrophoresis method from the invention can be used to differentiate between batches with different diastereomers composition of nusinersen by comparing the electropherogram. This comparison may be used to show the regulatory authorities sameness with the marketed product nusinersen.

The present invention is illustrated by the following Examples.

All CE analyses in the following examples were performed using Agilent 7100 Capillary electrophoresis system.

### Example 1

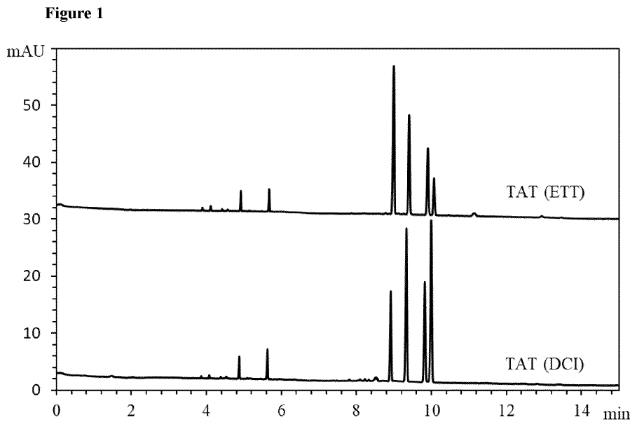

Separation of model sample designed as phosphorothioated trimer (TAT) synthesized by two different activators (ETT and DCI) known to have an effect on resulting diastereomer ratios, see FIG. 1.

Separation took place in PVA coated capillary (33 cm total length). The capillary was filled with gel, comprised of 7.2% PVP polymer (molecular mass 1,300,000) dissolved in background electrolyte. Background electrolyte was comprised of 0.1M HEPES/0.1M Histidine (pH 6.8). The sample was introduced into capillary by application of −10 kV. Separation took place in thermostated capillary (15° C.) by application of −20 kV. Analytes were detected by UV detection at 260 nm.

### Example 2

Comparison of CE separation of model sample designed as 5-mer with the following sequence: GCTGG.

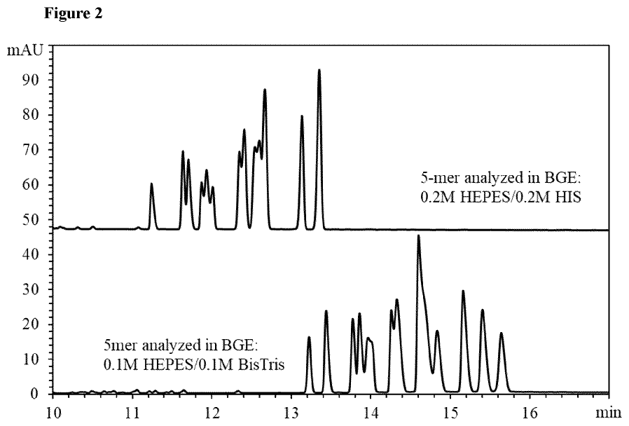

CE conditions were the same as in Example 1, moreover, different BGE compositions were also tested (0.2M HEPES/0.2M HIS and 0.1M HEPES/0.1M Bis-Tris), see FIG. 2.

### Example 3

Separation of phosphorothioated 18-mer oligonucleotide synthesized by two different activators (ETT and DCI) known to have an effect on resulting diastereomer ratios. The comparison of two 18-mer synthesized by using two different activators with two different batches of reference listed drug (Nusinersen).

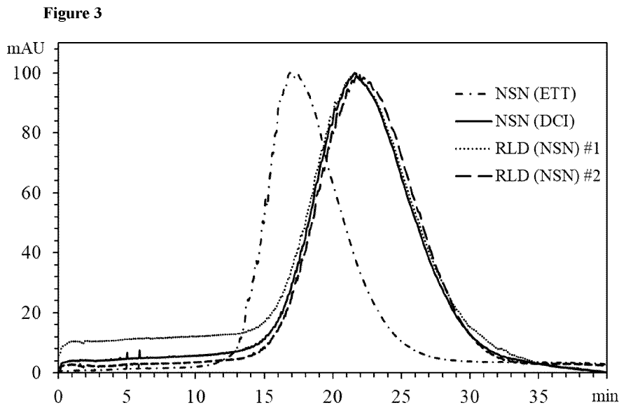

CE conditions were the same as in Example 1, except BGE, that comprised of 0.1M HEPES/0.1M Bis-Tris, see FIG. 3. UV absorbance signals were normalized for better comparison.

1. A method of identification and/or characterization of diastereomers mixtures of phosphorothioate oligonucleotides by capillary gel electrophoresis with a background electrolyte that has a pH 6 to 8, comprising the steps of:
a) preparing a gel matrix by dissolving a water soluble polymer containing a side chain having a functional group that interacts with diastereomers mixture to be analysed in a background electrolyte;
b) introducing the gel matrix in the capillary;
c) introducing the sample of diastereomers mixture of phosphorothioate to capillary;
d) applying an electric field greater than 200 volts/cm of capillary across the gel matrix in the capillary; and
e) detecting the individual diastereomers and/or the characteristic groups of partially separated diastereomers of phosphorothioate oligonucleotides.

2. The method of claim 1 wherein the background electrolyte solution is MES/HIS.

3. The method of claim 2 wherein the concentration of each of the components in the background electrolyte is from 0.02M to 0.3M.

4. The method of claim 1 wherein the background electrolyte solution is HEPES/HIS.

5. The method of claim 4 wherein the concentration of the background electrolyte is from 0.02M to 0.3M.

6. The method of claim 1 wherein the background electrolyte solution is HEPES/Bis-Tris.

7. The method of claim 6 wherein the concentration of the background electrolyte is from 0.02M to 0.3M.

8. The method of claim 1 wherein the water soluble polymer containing a side chain having a functional group that interacts with diastereomers mixture to be analysed is polyvinylpyrrolidone 1.3M or “copolymer of polyvinylpyrrolidone and vinyl acetate”.

9. The method of claim 1 wherein the concentration of the water soluble polymer containing a side chain having a functional group that interacts with diastereomers mixture to be analysed is more than 3% w/v.

10. The method of claim 1 wherein the capillary is thermostated to temperatures from 7 to 20° C.

11. The method of claim 1 wherein step (d) comprises applying an electric field of about 400 to 1000 volts/cm of capillary across the capillary.

12. The method of claim 1 wherein the phosphorothioate oligonucleotides is at least a 5-mer.

13. A capillary gel electrophoresis method of identification and/or characterization of diastereomers mixtures of phosphorothioate oligonucleotides according to claim 1, comprising the steps of:
(a) preparing a gel matrix by dissolving a water soluble polymer containing a side chain having a functional group that interacts with diastereomers mixture to be analysed, preferably polyvinylpyrrolidone 1.3M or “co-polymer polyvinylpyrrolidone and vinylacetate”, in a background electrolyte, preferably MES/HIS, HEPES/HIS or HEPES/Bis-Tris, that has a pH from 6.5 to 7.5,
(b) introducing the gel matrix in the capillary;
(c) introducing the sample of diastereomers mixture of phosphorothioate to capillary;
(d) applying an electric field greater than 200 volts/cm of capillary across the separation substrate in the capillary; and
(e) detecting the individual diastereomers and/or the characteristic groups of partially separated diastereomers of phosphorothioate oligonucleotides.

14. The method of claim 1 wherein the phosphorothioate oligonucleotide is nusinersen.

15. (canceled)

16. (canceled)
